(19) United States
(12) Patent Application Publication
(10) Pub. No.: US 2021/0317877 A1
(43) Pub. Date: Oct. 14, 2021

(54) ROLLING BEARING, WHEEL SUPPORT DEVICE, AND WIND POWER GENERATION ROTOR SHAFT SUPPORT DEVICE

(71) Applicant: NTN CORPORATION, Osaka (JP)

(72) Inventors: Masaki NAKANISHI, Mie (JP); Hidenobu MIKAMI, Mie (JP)

(21) Appl. No.: 17/266,552

(22) PCT Filed: Aug. 6, 2019
(86) PCT No.: PCT/JP2019/030812

§ 371 Date: Feb. 5, 2021

(30) Foreign Application Priority Data
Aug. 8, 2018 (JP) 2018-149640
Sep. 18, 2018 (JP) 2018-174174
Feb. 27, 2019 (JP) 2019-034126

(51) Int. Cl. F16C 33/62; F16C 19/36; F16C 23/08; F16C 19/06

(52) U.S. Cl. CPC F16C 33/62; F16C 19/364; F16C 33/56; F16C 19/06; F16C 2360/31; F16C 23/08

(57) ABSTRACT

To provide a rolling bearing superior in its seizure resistance, wear resistance, and corrosion resistance by improving peeling resistance of a DLC film and by showing the original properties of the DLC film, even when the rolling bearing is brought into contact with another member under a condition of a high load or an inferior lubrication state causing sliding or a condition in which foreign matters are mixed. A deep groove ball bearing (1) includes an inner ring (2) having an inner ring raceway surface (2a) on an outer circumference, an outer ring (3) having an outer ring raceway surface (3a) on an inner circumference, rolling elements (4) that roll between the inner ring raceway surface (2a) and the outer ring raceway surface (3a), a cage (5) that retains the rolling elements (4), and a hard film (8) formed on the inner ring raceway surface (2a) or the like. The hard film (8) is brought into rolling contact and sliding contact with other bearing component. The hard film (8) includes a foundation layer, a mixed layer formed on the foundation layer and having a gradient composition mainly formed of WC and DLC, and a surface layer formed on the mixed layer and mainly formed of DLC. The indentation hardness of the surface layer measured by a method defined in ISO 14577 is 9-22 GPa.

### TECHNICAL FIELD

The present invention relate to a rolling bearing in which a hard film including a diamond-like carbon is formed on an inner ring, an outer ring, a rolling element, and a cage surface, which are bearing components. Further, the present invention relates to a wheel support device and a wind power generation rotor shaft support device to which the rolling bearing is applied.

### BACKGROUND ART

A hard carbon film is a hard film called diamond-like carbon (hereinafter, referred to as DLC. A film or a layer mainly formed of DLC is also called a DLC film or a DLC layer). Various names are given to the hard carbon. For example, it is called hard amorphous carbon, amorphous carbon, hard amorphous-type carbon, i-carbon, and diamond-shaped carbon. These terminologies are not clearly distinguished from one another.

As the essential quality of the DLC for which the above-described terminologies are used, the DLC has a structure in which diamond and graphite are mixed with each other and thus its structure is intermediate between that of the diamond and that of the graphite. The DLC has high hardness almost equal to that of the diamond and is excellent in its wear resistance, solid lubricating property, thermal conductivity, chemical stability, and corrosion resistance. Therefore the DLC has been utilized as protection films of dies, tools, wear-resistant mechanical parts, abrasive materials, sliding members, magnetic and optical parts. As methods of forming the DLC film, a physical vapor deposition (hereinafter, referred to as PVD) method such as a sputtering method and an ion plating method; a chemical vapor deposition (hereinafter, referred to as CVD) method; and an unbalanced magnetron sputtering (hereinafter, referred to as UBMS) method are adopted.

Conventionally, attempts are made to form the DLC film on raceway surfaces of bearing rings of a rolling bearing, rolling contact surfaces of rolling elements thereof, sliding contact surface of a cage thereof. Extremely large internal stress is generated when the DLC film is formed. Although the DLC film has high hardness and high Young's modulus, the DLC film has extremely small deformability. Thus, the DLC film has disadvantages that it is low in its adhesiveness to a base material and liable to peel therefrom. Thus, in forming the DLC film on the above-described surfaces of the bearing components of the rolling bearing, it is necessary to improve its adhesiveness to the surfaces of the bearing components.

For example, in order to improve the adhesiveness of the DLC film to the base material by disposing an intermediate layer, a rolling device in which a foundation layer that contains any one or more elements selected from among chromium (hereinafter, referred to as Cr), tungsten (hereinafter, referred to as W), titanium (hereinafter, referred to as Ti), silicon (hereinafter, referred to as Si), nickel, and iron as its composition; an intermediate layer that is formed on the foundation layer and contains the same constituent elements as those of the foundation layer and carbon such that the content rate of the carbon is larger at the side opposite to the foundation layer than at the side of the foundation layer; and a DLC layer that is formed on the intermediate layer and contains argon and carbon such that the content rate of the argon is not less than 0.02 mass % nor more than 5 mass %, has been proposed (see Patent Document 1).

In order to improve the adhesiveness of the DLC film to the base material by an anchoring effect, a rolling bearing in which unevenness of which height is 10-100 nm and average width is not more than 300 nm are formed on a raceway surface by means of ion bombardment process and the DLC film is formed on the raceway surface, has been proposed (see Patent Document 2).

For example, the rolling bearing is applied to a wheel support device for rotatably supporting a wheel to a suspension device of a vehicle. In the wheel support device that supports a non-driving wheel such as a front wheel in a rear wheel driving vehicle, two rolling bearings are mounted on an axle (knuckle spindle) disposed on a steering knuckle, a flange is disposed on an outer diametrical surface of an axle hub rotatably supported by the rolling bearings, and a brake drum of a braking device and a wheel disc for a wheel are mounted by using a stud bolt disposed on the flange and a nut screwed with the stud bolt. Further, a back plate is mounted to the flange disposed on the steering knuckle, and a braking mechanism that applies the braking force to the brake drum is supported by the back plate. In such a wheel support device described above, a tapered roller bearing having a large load capacity and high rigidity is adopted as the rolling bearing that rotatably supports the axle hub. The tapered roller bearing is lubricated by grease filled between the axle and the axle hub.

In the rolling bearing used in the wheel support device, a lubrication oil film of the grease is apt to be broken due to the use condition of high speed and high load, in particular a sliding movement of an end surface of the tapered roller bearing at a large diameter side against an end surface of the flange. When the lubrication oil film is broken, metal contact is generated, and thereby heat generation and defect of increasing the friction wear might be generated. Thus, it is necessary to improve the lubricating property and the load resistance under the high speed and high load and to prevent the metal contact due to the break of the lubrication oil film. Accordingly, the defect is suppressed using the grease containing an extreme pressure agent.

Conventionally, as an example of the wheel support device to which the high load is applied under the high speed, a railway vehicle bearing in which grease including an organic metal compound containing metal selected from among nickel, tellurium, selenium, copper, and iron at not more than 20 mass % against the total mass of the grease, has been known (see Patent Document 3).

However, as the use condition of the roller bearing becomes severe, for example the lubrication under the high speed condition such that dN value is not less than 100,000, the roller bearing might be difficult to be used with the conventional grease. In the wheel support device roller bearing, rolling friction is generated between the raceway surfaces of the inner ring and the outer ring and the roller, which is a rolling element, and sliding friction is generated between the flange and the roller. Since the sliding friction is larger than the rolling friction, seizure of the flange is apt to be generated as the use condition becomes severe. Accordingly, a replacement operation of the grease is frequently performed, so that maintenance-free cannot be achieved.

### PRIOR ART DOCUMENTS

### Patent Documents

### Patent Document 1: Japanese Patent No. 4178826

### Patent Document 2: Japanese Patent No. 3961739

### Patent Document 3: Japanese Patent Application Laid-Open Publication No. 10-017884

### SUMMARY OF THE INVENTION

### Problems to be Solved by the Invention

It is not easy to prevent flaking under a high contact surface pressure caused by a rolling and sliding movement, in particular, it might be more difficult to prevent the flaking under a lubrication operation condition that may cause much stronger shear force due to the sliding friction. The sliding surface to which the DLC film is likely applied is apt to be inferior in lubrication state and thereby sliding is caused, and therefore the operation condition might be severe compared to that of the general rolling bearing. Further, since the rolling bearing may be used in a state in which foreign matters are mixed, it is necessary to suppress the seizure, the wear or the like under such a condition. However, it is further difficult to secure the peeling resistance against the local high surface pressure and the deformation of the base material when the foreign matters are bit.

The techniques disclosed in the above Patent Documents 1 and 2 have been proposed to prevent the peeling of the hard film. However, there is room for further improvement of a film structure or a film forming condition in a configuration to which the DLC film is applied in order to satisfy required properties of the obtained rolling bearing depending on the use condition.

An object of the present invention is, in order to solve such a problem, to provide a rolling bearing superior in its seizure resistance, wear resistance, and corrosion resistance by improving peeling resistance of a DLC film and by showing the original properties of the DLC film, even when the rolling bearing is brought into contact with another member under a condition of a high load or an inferior lubrication state causing sliding or a condition in which foreign matters are mixed. Further, another object of the present invention is to provide a wheel support device and a wind power generation rotor shaft support device to which the rolling bearing described above is applied.

### Means for Solving the Problem

A rolling bearing includes: an inner ring having an inner ring raceway surface on an outer circumference; an outer ring having an outer ring raceway surface on an inner circumference; rolling elements that roll between the inner ring raceway surface and the outer ring raceway surface; a cage that retains the rolling elements, wherein the inner ring, the outer ring, the rolling elements, and the cage are formed of iron-based material; and a hard film including: a foundation layer formed directly on a surface of at least one bearing component selected from among the inner ring, the outer ring, the rolling element, and the cage; a mixed layer formed on the foundation layer and mainly formed of tungsten carbide (hereinafter, referred to as WC) and DLC; and a surface layer formed on the mixed layer and mainly formed of DLC. The hard film is formed to be brought into rolling contact and sliding contact with other bearing component. The indentation hardness of the surface layer measured by a method defined in ISO 14577 is 9-22 GPa. The mixed layer has a composition in which a content rate of the WC in the mixed layer is continuously or stepwise decreased and a content rate of the DLC in the mixed layer is continuously or stepwise increased from a side of the foundation layer toward a side of the surface layer.

The indentation hardness of the surface layer may be 10-15 GPa.

The surface layer may have a gradient layer of which the indentation hardness is smaller than that of the surface layer, at a side of the mixed layer.

The iron-based material may be high carbon chromium bearing steel, carbon steel, tool steel, or martensitic stainless steel.

The foundation layer may be mainly formed of Cr and WC.

A wheel support device according to the present invention includes the rolling bearing according to the present invention mounted to an outer diametrical surface of an axle to rotatably support a rotation member that is rotated together with a wheel.

The rolling bearing may be a tapered roller bearing. The tapered roller bearing may include an end surface at a large diameter side of a tapered roller, which is the rolling element, and an end surface of a large flange formed on the inner ring. The end surface at the large diameter side of the tapered roller may be formed to be brought into rolling contact and sliding contact with the end surface of the large flange. The hard film may be formed on at least one of the end surface at the large diameter side of the tapered roller and the end surface of the large flange of the inner ring.

The rolling bearing may be formed to support a rotor shaft to which a blade of a wind power generator is mounted. The rolling bearing may be formed as a double-row self-aligning roller bearing including: rollers interposed between the inner ring and the outer ring, as the rolling elements to be aligned in two rows in an axial direction. The outer ring raceway surface may be formed in a spherical shape. The outer circumference of each of the rollers may be formed in a shape along the outer ring raceway surface.

The inner ring may include: an intermediate flange disposed on the outer circumference of the inner ring, between the rollers in the two rows, the intermediate flange being formed to be brought into sliding contact with an end surface at an inner side in the axial direction of each of the rollers; and small flanges disposed at both ends of the outer circumference of the inner ring, each of the small flanges being formed to be brought into sliding contact with an end surface at an outer side in the axial direction of each of the rollers. The hard film may be formed on the outer circumference of the roller in at least one of the two rows.

A wind power generation rotor shaft support device according to the present invention includes one or more bearings disposed in a housing, the bearings being formed to support a rotor shaft to which a blade is mounted. At least one of the bearings is formed as the double-row self-aligning roller bearing. Apart of the double-row self-aligning roller bearing, in a row far away from the blade is formed to receive a large load compared to a part of the double-row self-aligning roller bearing, in a row close to the blade.

### Effect of the Invention

The rolling bearing according to the present invention has the hard film having a predetermined film structure including DLC, on the surface of at least one bearing component selected from among the inner ring, the outer ring, the rolling element, and the cage. The rolling bearing is used in a condition in which the hard film is brought into rolling contact and sliding contact with other bearing component. An intermediate layer is the mixed layer of WC and DLC (WC/DLC), which has a gradient composition, and thereby the residual stress after the film is formed is hardly concentrated. In addition, the indentation hardness of the surface layer is 9-22 GPa. Accordingly, superior seizure resistance of the hard film can be obtained even in a case in which the hard film is brought into contact with other component under a condition of a high load or an inferior lubrication state causing sliding or a condition in which foreign matters are mixed.

With the configuration described above, the hard film, for example formed on a rolling contact surface of the rolling element, is superior in its peeling resistance and thereby the hard film can show the original properties of DLC. As a result, the rolling bearing becomes superior in its seizure resistance, wear resistance, and corrosion resistance. Consequently, the damage is less on the sliding surface in a severe lubrication state including a non-lubrication state or in an environment in which foreign matters are mixed, and thereby the lifetime thereof can be made long.

The wheel support device according to the present invention has the rolling bearing according to the present invention as a rolling bearing mounted to the outer diametrical surface of the axle, and thereby superior friction wear resistance and long term durability of the sliding surface can be obtained.

The wind power generation rotor shaft support device according to the present invention supports the rotor shaft to which the blade is mounted, using the rolling bearing according to the present invention. Thus, superior peeling resistance of the hard film can be obtained under a condition of a high load or an inferior lubrication state causing sliding, and thereby the lifetime of the bearing can be made long and maintenance-free thereof can be achieved. Further, the bearing is formed as a double-row self-aligning roller bearing having the rollers aligned in two rows in an axial direction, interposed between the inner ring and the outer ring, and the hard film is formed on the outer circumference of the roller in at least one of the two rows. Thus, the bearing is suitable to a unique use state for the wind power generator rotor shaft bearing in which a relatively large thrust load is applied to the roller in one of the two rows.

### BRIEF DESCRIPTION OF THE DRAWINGS

FIGS. 1(a) and 1(b) are cross-sectional views illustrating one example of a rolling bearing according to the present invention.

FIG. 2 is a cross-sectional view illustrating another example of the rolling bearing according to the present invention.

FIG. 3 is a schematic cross-sectional view illustrating a structure of a hard film.

FIG. 4 is a cross-sectional view illustrating one example of a wheel support device.

FIG. 5 is a partially cut perspective view illustrating one example of a tapered roller bearing according to the present invention.

FIG. 6 is a partially cut perspective view illustrating another example of a tapered roller bearing according to the present invention.

FIG. 7 is a schematic view illustrating a whole wind power generator including a wind power generation rotor shaft support device.

FIG. 8 is a view illustrating the wind power generation rotor shaft support device.

FIG. 9 is a schematic cross-sectional view illustrating a double-row self-aligning roller bearing according to the present invention.

FIG. 10 is a view illustrating a rotor shaft support bearing in a conventional wind power generator.

FIG. 11 is a schematic view illustrating a film forming principle of a UBMS method.

FIG. 12 is a schematic view illustrating a UBMS device.

FIG. 13 is a view illustrating an outline of a reciprocation sliding test machine.

FIG. 14 is a schematic view illustrating a two-cylinder test machine.

FIG. 15 is a graph illustrating a measurement example of a swelling height of an indentation.

### MODE FOR CARRYING OUT THE INVENTION

A hard film such as a DLC film has residual stress therein. The residual stress is largely different depending on an influence of a film structure or a film forming condition. As a result, the peeling resistance is largely affected. Also, the peeling resistance is changed depending on a use condition of the hard film. The prevent inventors conducted a study regarding the hard film formed on a surface of a rolling bearing using a reciprocation sliding test machine, for example under a condition of an inferior lubrication state (boundary lubrication) and thereby causing a sliding contact. As a result of the study, the present inventors found that the peeling resistance can be improved under the above-described condition by adopting a specific film structure of the hard film and especially by setting indentation hardness of a surface layer of the hard film in a predetermined range. Further, the present inventors found that the hard film is superior in peeling resistance in a lubrication state in which foreign matters are mixed, which is a practical use condition of the bearing, and that the hard film can suppress the damage of a raceway surface due to the indentation caused by the foreign matter. The present invention has been derived from such knowledge.

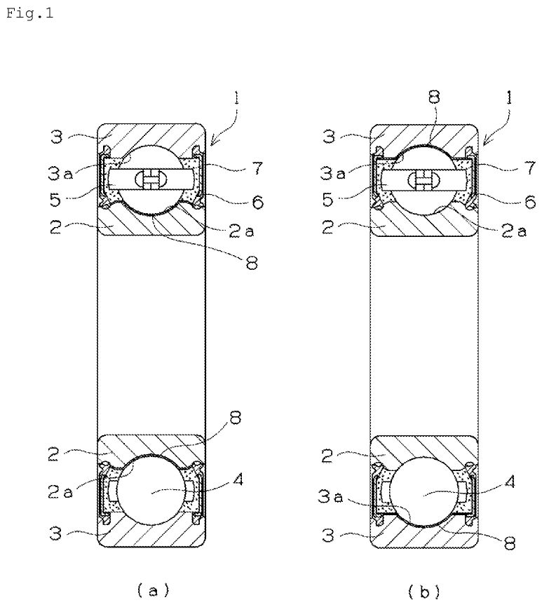

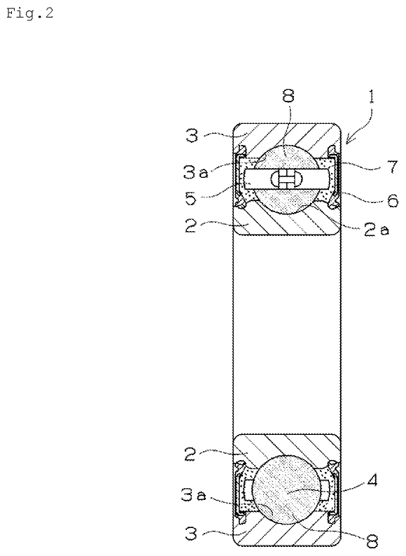

A rolling bearing according to the present invention will be described with reference to FIGS. 1(a) and 1(b), and FIG. 2. FIGS. 1(a) and 1(b) illustrate cross-sectional views of a deep groove ball bearing in which a hard film described below is formed on an inner ring raceway surface and an outer ring raceway surface. FIG. 2 illustrates a cross-sectional view of the deep groove ball bearing in which the hard film is formed on a rolling contact surface of a rolling element. A deep groove ball bearing 1 is provided with an inner ring 2 having an inner ring raceway surface 2a on its outer circumference, an outer ring 3 having an outer ring raceway surface 3a on its inner circumference, and a plurality of rolling elements 4 that roll between the inner ring raceway surface 2a and the outer ring raceway surface 3a. A cage 5 retains the rolling elements 4 at regular intervals. A sealing member 6 seals an opening formed at each of axial ends of the inner ring and the outer ring. Grease 7 is sealed in a space of the bearing. As the grease 7, known grease for the rolling bearing can be adopted.

For example in the rolling bearing shown in FIG. 1(a), a hard film 8 is formed on an outer circumferential surface (including the inner ring raceway surface 2a) of the inner ring 2. In the rolling bearing shown in FIG. 1(b), the hard film 8 is formed on an inner circumferential surface (including the outer ring raceway surface 3a) of the outer ring 3. However, the hard film may be formed on at least one surface of the inner ring, the outer ring, the rolling element, and the rolling element in accordance with an applicable use thereof.

In the rolling bearing shown in FIG. 2, the hard film 8 is formed on the rolling contact surface of each of the rolling elements 4. Since the rolling bearing shown in FIG. 2 is a deep groove ball bearing, the rolling elements thereof are balls, and the rolling contact surface of each of the rolling elements is entirely a spherical surface. In the case in which the hard film 8 is formed on the rolling elements of a cylindrical roller bearing or a tapered roller bearing used as a rolling bearing other than those shown in the figures, the hard film should be formed on at least the rolling contact surface (cylindrical outer circumference) of each of the rolling elements. In particular, a tapered roller bearing used in a wheel support device and a double-row self-aligning roller bearing used in a wind power generation rotor shaft support device will be described below.

As shown in FIGS. 1(a) and 1(b), and FIG. 2, in order to guide the balls, which are the rolling elements 4, the inner ring raceway surface 2a of the deep groove ball bearing is formed as a circular curved surface which is an arc-groove shape in its section in an axial direction. Similarly, the outer ring raceway surface 3a is a circular curved surface which is an arc-groove shape in its section in an axial direction. As a diameter of a steel ball is dw, the curvature radius of the arc groove is approximately 0.51-0.54 dw. In the case in which the cylindrical roller bearing or the tapered roller bearing is used as the rolling bearing other than those shown in the figures, in order to guide the rollers of the bearing, each of the inner ring raceway surface and the outer ring raceway surface is formed in a curved surface in at least a circumferential direction thereof. Since a barrel-shaped roller is used as the rolling element in the case of a self-aligning roller bearing, each of the inner ring raceway surface and the outer ring raceway surface is formed in a curved surface in the axial direction thereof in addition to the circumferential direction thereof. In the rolling bearing according to the present invention, each of the inner ring raceway surface and the outer ring raceway surface may have any of the above-described configurations.

In the deep groove ball bearing 1 according to the present invention, the inner ring 2, the outer ring 3, the rolling element 4 and the cage 5, which are bearing components on which the hard film 8 is formed, are formed of iron-based material. As an iron-based material, any steel generally used in a bearing component may be adopted. Examples of the iron-based material include high carbon chromium bearing steel, carbon steel, tool steel, and martensitic stainless steel.

In these bearing components, the hardness of each of the surfaces on which the hard film is formed is preferably set to Vickers hardness of Hv 650 or more. By setting the hardness of the surface to Vickers hardness of Hv 650 or more, a difference between the hardness of the surface and that of the hard film (foundation layer) can be decreased and the adhesiveness to the hard film can be improved.

It is preferable that a nitrided layer is formed by means of nitriding treatment, on the surface on which the hard film is to be formed, before the hard film is formed on the surface. As the nitriding treatment, it is preferable to subject the surface of a base material to plasma nitriding treatment because the plasma nitriding treatment makes it difficult for an oxidized layer which deteriorates the adhesiveness between the hard film and the surface of the base material to be generated on the surface of the base material. It is preferable that the hardness of the surface after the nitriding treatment is Hv 1000 or more in Vickers hardness in order to further improve the adhesiveness to the hard film (foundation layer).

It is preferable that a surface roughness Ra of the surface on which the hard film is to be formed is set to 0.05 μm or less. In the case in which the surface roughness Ra exceeds 0.05 μm, the hard film is hardly formed at the distal ends of the projections of the unevenness and a film thickness becomes locally thin.

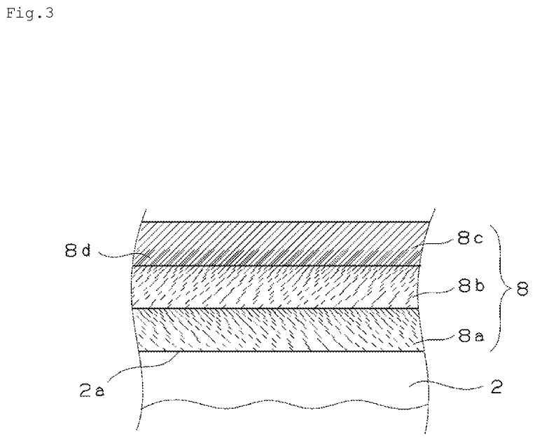

A structure of the hard film according to the present invention will be described with reference to FIG. 3. FIG. 3 is a schematic cross-sectional view illustrating the structure of the hard film 8 shown in FIG. 1(a). As shown in FIG. 3, the hard film 8 has a three-layer structure formed of (1) a foundation layer 8a formed directly on the inner ring raceway surface 2a of the inner ring 2, (2) a mixed layer 8b mainly formed of WC and DLC, disposed on the foundation layer 8a, and (3) a surface layer 8c mainly formed of DLC, disposed on the mixed layer 8b. In the present invention, the structure of the hard film is the three-layer structure, so that a sudden change in the properties (hardness, modulus of elasticity, and the like) can be avoided.

The foundation layer 8a is formed directly on a surface of each of the bearing components served as base materials. The material and the structure of the foundation layer are not especially limited as long as the adhesiveness to the base material is secured. Examples of the material include Cr, W, Ti, and Si. Of these materials, it is preferable that the material contains Cr because of its superior adhesiveness to the bearing component (for example, high carbon chromium bearing steel) served as a base material.

Also considering the adhesiveness of the foundation layer 8a to the mixed layer 8b, the foundation layer 8a is mainly formed of Cr and WC. WC has the hardness and the modulus of elasticity intermediate between those of Cr and DLC, and the concentration of the residual stress is hardly caused after the foundation layer is formed. In particular, it is preferable that the foundation layer 8a has a gradient composition in which the content rate of Cr is decreased and the content rate of WC is increased from a side of the inner ring 2 toward a side of the mixed layer 8b. With this, superior adhesiveness of the foundation layer 8a to both of the inner ring 2 and the mixed layer 8b can be obtained.

The mixed layer 8b is formed as an intermediate layer interposed between the foundation layer and the surface layer. As described above, WC used in the mixed layer 8b has the hardness and the modulus of elasticity intermediate between those of Cr and DLC and makes it difficult for the residual stress to concentrate in the hard film after formed. Since the mixed layer 8b has the gradient composition in which the content rate of WC in the mixed layer is continuously or stepwise decreased and the content rate of DLC in the mixed layer is continuously or stepwise increased from a side of the foundation layer 8a toward a side of the surface layer 8c, superior adhesiveness of the mixed layer 8b to both of the foundation layer 8a and the surface layer 8c can be obtained. The mixed layer 8b has a structure in which WC and DLC are physically connected to each other, so that the break or the like in the mixed layer 8b can be prevented. Further, the content rate of DLC is high at the side of the surface layer 8c, and thereby superior adhesiveness of the mixed layer 8b to the surface layer 8c can be obtained.

In the mixed layer 8b, DLC having high non-adhesiveness can be connected to the foundation layer 8a owing to an anchoring effect caused by the presence of WC.

The surface layer 8c is mainly formed of DLC. It is preferable that the surface layer 8c has a relaxing layer 8d at a side of the mixed layer 8b. The relaxing layer is formed to avoid a sudden change of the parameters(introduction amount of hydrocarbon-based gas, vacuum degree, and bias voltage) relating to a film forming condition in a case in which the parameters for the mixed layer 8b and the parameters for the surface layer 8c are different from each other. The relaxing layer is formed by continuously or stepwise changing at least one of the parameters. More specifically, a parameter relating to the film forming condition at a time when the outermost surface of the mixed layer 8b is formed is set as a starting point, and a parameter relating to a final film forming condition of the surface layer 8c is set as a termination point. Each of the parameters is changed continuously or stepwise within this range. With this, there is no large difference between the properties (hardness, modulus of elasticity, and the like) of the mixed layer 8b and those of the surface layer 8c and thus further superior adhesiveness therebetween can be obtained. By increasing the bias voltage continuously or stepwise, a component rate of a diamond structure (sp³) in a DLC structure is increased rather than a component rate of a graphite structure (sp²) in the DLC structure, and thereby the hardness of the layers becomes gradient (rises).

As described in examples below, in order to improve the peeling resistance of the hard film when the hard film is brought into sliding contact with other component in a non-lubrication state, it is important to set the surface hardness of the surface layer of the hard film in a predetermined range. Further, the surface hardness of the surface layer of the hard film is also important when the hard film is brought into rolling and sliding contact with other component in a lubrication state with foreign matter mixed. In the rolling bearing of the present invention, the indentation hardness of the surface layer of the hard film measured by a method of ISO 14577 is set in a range of 9-22 GPa, preferably in a range of 10-21 GPa, more preferably in a range of 10-15 GPa, further more preferably in a range of 10-13 GPa. In a configuration in which the surface layer 8c has the relaxing layer 8d, the indentation hardness of the relaxing layer is smaller than that of the surface layer 8c. The indentation hardness of the relaxing layer is set, for example, in a range of 9-22 GPa. The hardness of relaxing layer is continuously or stepwise increased from a side of the mixed layer.

It is preferable to set the thickness of the hard film 8 (total of three layers) to 0.5-3.0 μm. When the thickness of the hard film is less than 0.5 μm, there are cases in which the hard film is inferior in its wear resistance and mechanical strength. When the thickness of the hard film is more than 3.0 μm, it is liable to peel off the surface of the base material. It is also preferable to set the ratio of the thickness of the surface layer 8c to that of the hard film 8 to not more than 0.8. When the above-described ratio exceeds 0.8, the gradient composition for physically connecting WC and DLC in the mixed layer 8b to each other is liable to be uncontinuous, and thereby the adhesiveness of the mixed layer 8b might be deteriorated.

By adopting the hard film 8 of the three layers having the foundation layer 8a, the mixed layer 8b, and the surface layer 8c, superior peeling resistance can be obtained.

The hard film having the above-described structure and properties is formed on the rolling bearing of the present invention, so that the hard film can be prevented from wearing and peeling off even in a case in which the load caused by the sliding contact is applied to the hard film when in use. Consequently, even in a severe lubrication state, the damage of the raceway surface and the like can be suppressed and thereby the lifetime thereof can be made longer. Further, also in the lubrication state in which foreign matters are mixed, the damage of the raceway surface to be caused by the indentation due to the foreign matters can be suppressed, and thereby the lifetime thereof can be made longer. Ina rolling bearing in which grease has been sealed, when a newly formed metal surface is exposed due to the damage of the raceway surface or the like, the deterioration of the grease is accelerated by catalytic action. While, in the rolling bearing according to the present invention, the damage of the raceway surface or the rolling contact surface caused by metal contact can be prevented by the hard film and the deterioration of the grease can be also prevented.

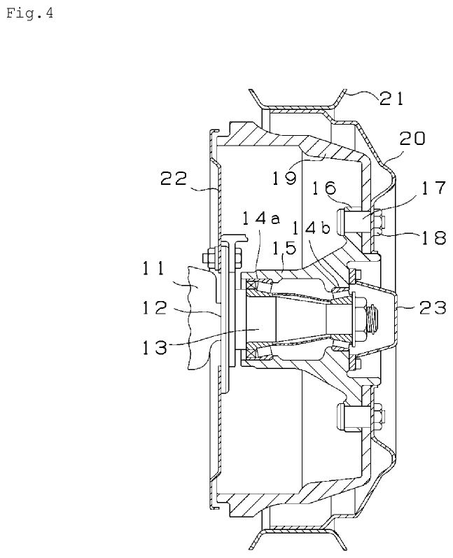

An example of a wheel support device to which the rolling bearing according to the present invention is applied will be described with reference to FIG. 4. FIG. 4 is a cross-sectional view illustrating the wheel support device according to the present invention. As shown in FIG. 4, a flange 12 and an axle 13 are disposed in a steering knuckle 11. An axle hub 15, which is a rotation member, is rotatably supported by a pair of tapered roller bearings 14a and 14b mounted on an outer diametrical surface of the axle 13. The axle hub 15 has a flange 16 on an outer diametrical surface thereof. A brake drum 19 of a brake device and a wheel disc 20 of a wheel are mounted using a stud bolt 17 disposed on the flange 16 and a nut 18 screwed with the stud bolt 17. A rim 21 is mounted to an outer diametrical surface of the wheel disc 20. A tire is mounted onto the rim. In FIG. 4, the tapered roller bearings 14a and 14b correspond to the wheel support device.

A back plate 22 of the brake device is mounted to the flange 12 of the steering knuckle 11 by fastening the stud bolt 17 and the nut 18 to each other. A braking mechanism that applies braking force to the brake drum 19 is supported on the back plate 22. The braking mechanism is not shown in the drawings.

A pair of the tapered roller bearings 14a and 14b that rotatably supports the axle hub 15 is lubricated by the grease sealed in the axle hub 15. In order to prevent the grease from leaking to the outside from the tapered roller bearing 14b and prevent muddy water from entering into the tapered roller bearing 14b, a grease cap 23 is mounted at an outer end surface of the axle hub 15 to cover the tapered roller bearing 14b.

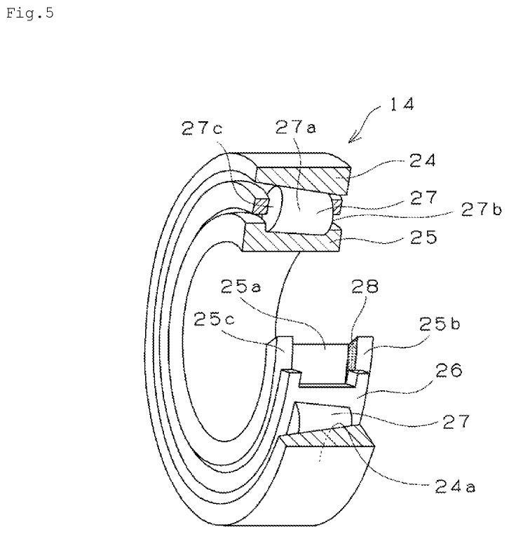

One example of the tapered roller bearing of the wheel support device according to the present invention will be described with reference to FIG. 5. FIG. 5 is a partially cut perspective view illustrating one example of the tapered roller bearing. The tapered roller bearing 14 is provided with an inner ring 25 having a tapered inner ring raceway surface 25a on an outer circumference thereof, an outer ring 24 having a tapered out ring raceway surface 24a on an inner circumference thereof, a plurality of tapered rollers 27 that roll between the inner ring raceway surface 25a and the outer ring raceway surface 24a, and a cage 26 that retains the tapered rollers 27 at pocket parts thereof in a rolling manner. The cage 26 is formed by connecting a large diameter ring part and a small diameter ring part via a plurality of columns. The cage 26 houses the tapered rollers 27 in the pocket parts between the columns. In the inner ring 25, a large flange 25c is formed integrally on an end at a large diameter side, and a small flange 25b is formed integrally on an end at a small diameter side. The inner ring in the tapered roller bearing has a tapered inner ring raceway surface, and therefore the inner ring has the large diameter side and the small diameter side when seen in an axial direction thereof. The “small flange” is formed on the end at the small diameter side, and the “large flange” is formed on the end at the large diameter side.

In the configuration described above, a rolling contact surface (tapered surface) 27a of the tapered roller 27 causes rolling friction against the inner ring raceway surface 25a and the outer ring raceway surface 24a. An end surface (small end surface) 27b at the small diameter side of the tapered roller 27 causes sliding friction against the inner end surface of the small flange 25b. An end surface (large end surface) 27c at the large diameter side of the tapered roller 27 causes sliding friction against the inner end surface of the large flange 25c. Further, the rolling friction and the sliding friction are caused between the tapered roller 27 and the cage 26. For example, the small end surface 27 b of the tapered roller 27 causes the sliding friction against an end surface of a small diameter ring that forms the pocket part, and the large end surface 27c of the tapered roller 27 causes the sliding friction against an end surface of a large diameter ring that forms the pocket part. The grease described above is sealed to reduce these frictions. As the grease, known grease for the rolling bearing can be adopted.

Since the tapered roller 27 is pressed to the large diameter side in using the tapered roller bearing 14, especially large load is applied to portions of the large flange 25c and the tapered roller 27 that are brought into sliding contact to each other. Thus, these portions are damaged easily and thereby the lifetime of the bearing is affected by the damage of these portions.

The wheel support device according to the present invention has a feature that the hard film having the indentation hardness within the predetermined range is formed on the surfaces, which are brought into sliding contact (in particular, in the boundary lubrication state) to each other, of the components in the device. Thus, superior peeling resistance of the hard film in sliding contacting with other component in the inferior lubrication state can be obtained. Further, when the bearing is used for the wheel support device, foreign matters might be mixed into the bearing from an outside. However, since the hard film is formed, superior peeling resistance can be obtained even in a state in which the foreign matters are mixed. Further, since the swelling of the indentation caused on a bearing rolling surface is removed by a cutting effect due to the hard film, peeling caused by the indentation can be favorably prevented. The low friction and the metal contact prevention effect of the hard film cause superior seizure resistance of the flange or the like of the tapered roller bearing.

As an area on which the hard film is formed, the hard film is formed on the inner ring, which is a bearing component, in the tapered roller bearing 14 shown in FIG. 5. Specifically, the hard film 28 is formed on each of the inner end surface of the flanges (small flange 25b and large flange 25c) of the inner ring 25. In a configuration in which the hard film is formed on the flange of the inner ring, considering that the sliding friction on the large flange is larger than the sliding friction on the small flange, it is preferable that the hard film is formed on at least an inner end surface of the large flange. The hard film 28 may be formed on the inner ring raceway surface 25a.

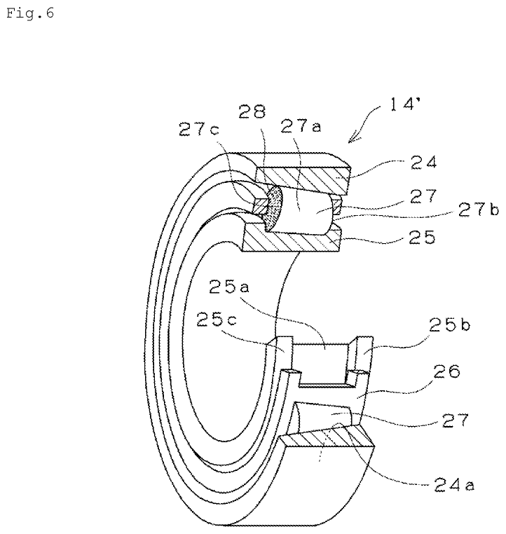

In a tapered roller bearing 14′ shown in FIG. 6, the hard film is formed on a tapered roller, which is a bearing component. Specifically, the hard film 28 is formed on each of the small end surface 27b and the large end surface 27c, which are end surfaces in the axial direction, of the tapered roller 27. Similar to the configuration described above, considering the sliding friction, it is preferable that the hard film is formed on at least the large end surface of the tapered roller. The hard film 28 may be formed on the rolling contact surface 27a. In such a case, the hard film is formed on a whole of the surface of the tapered roller 27.

The area on which the hard film is formed in the tapered roller bearing is not limited to the areas shown in FIG. 5 and FIG. 6. Accordingly, the hard film may be formed on any surface of at least one bearing component selected from among the inner ring, the outer ring, the rolling element, and the cage that are brought into rolling contact and sliding contact to each other. For example, the hard film may be formed on the inner end surface of the small diameter ring or the inner end surface of the large diameter ring of the cage that is brought into rolling contact and sliding contact with the small end surface or the large end surface of the tapered roller. Further, in the tapered roller bearing in which the small flange and the large flange are formed on the outer ring, the hard film may be formed on the inner end surfaces of the flanges.

FIG. 4 to FIG. 6 show the tapered roller bearing in the wheel support device as a rolling bearing, however a bearing that causes rolling and sliding movement between the bearing components may be adopted instead of the tapered roller bearing. Examples of the rolling bearing include a cylindrical roller bearing, a self-aligning roller bearing, a needle roller bearing, a thrust cylindrical roller bearing, a thrust tapered roller bearing, a thrust needle roller bearing, and a thrust self-aligning roller bearing. For example, in the cylindrical roller bearing, both end parts in an axial direction of a roller are brought into rolling contact and sliding contact with flanges at both ends in the axial direction of a raceway ring.

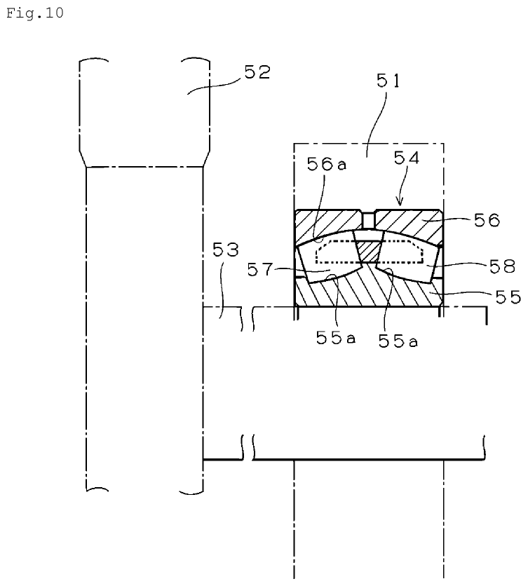

A wind power generator to which the rolling bearing according to the present invention is applied will be described. Conventionally, as a rotor shaft bearing in a large wind power generator, a large double-row self-aligning roller bearing 54 as shown in FIG. 10 is generally adopted. A rotor shaft 53 to which a blade 52 is mounted is rotated by receiving wind power to accelerate the rotation speed using a speed increaser (not shown) and to rotate a generator, so that electric power is generated. When electric power is generated while receiving the wind power, the rotor shaft 53 that supports the blade 52 receives an axial direction load (bearing thrust load) and a radial direction load (bearing radial load) due to the wind power applied to the blade 52. The double-row self-aligning roller bearing 54 can receive the radial load and the thrust load at the same time, absorb an incline of the rotor shaft 53 caused by an accuracy error or amount error of a bearing housing 51 in order to sustain the aligning performance, and absorb the deformation of the rotor shaft 53 in operating. Thus, the double-row self-aligning roller bearing 54 is suitably used as a power generator rotor shaft bearing (see the catalogue of NTN CORPORATION “The New Generation of NTN Bearings for Wind Turbine” A65. CAT. No. 8404/04/JE, May 1, 2003).

As shown in FIG. 10, in the double-row self-aligning roller bearing that supports a rotor shaft for the wind power generation, the thrust load is larger than the radial load. Thus, a roller 58 at a row that receives the thrust load among the double-row rollers 57 and 58 mainly receives the radial load and the thrust load at the same time. Accordingly, the rolling fatigue lifetime is made short. Further, since the thrust load is applied, the sliding movement is caused on a flange, and thereby the flange is worn. In addition, since the load at an opposite row is lightened, the roller 57 is slid on raceway surfaces 55a and 56a of an inner ring 55 and an outer ring 56, and thereby damage or wear on a surface of the roller 57 is caused. Thus, a large size bearing is adopted to solve the problems described above, however the capacity at the low load side becomes excessively large, and therefore it is uneconomical. Also, since the wind power generator rotor shaft bearing is operated in an unmanned state or arranged at a high place due to the large size of the blade 52, maintenance-free of the wind power generator rotor shaft bearing is desired.

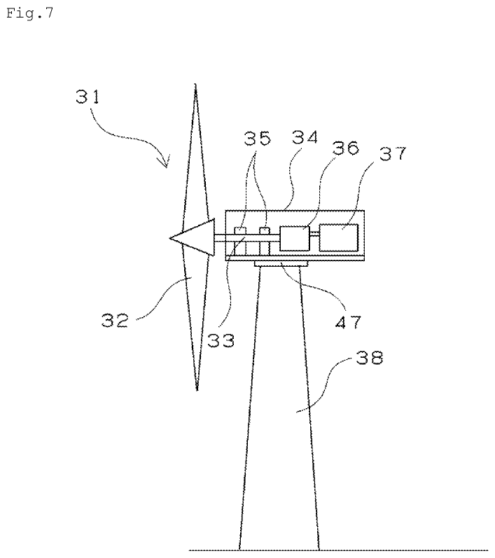

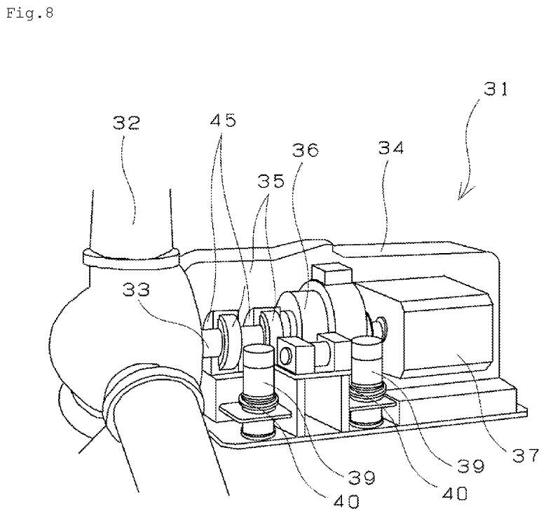

In order to solve the problems described above, the rolling bearing according to the present invention can be applied to the wind power generation rotor shaft support device, as the double-row self-aligning roller bearing. An example in which the rolling bearing according to the present invention is applied to the wind power generation rotor shaft support device will be described with reference to FIG. 7 and FIG. 8. FIG. 7 is a schematic view illustrating a whole of the wind power generator including the wind power generation rotor shaft support device according to the present invention. FIG. 8 is a view illustrating the wind power generation rotor shaft support device shown in FIG. 7. As shown in FIG. 7, in a wind power generator 31, a rotor shaft 33 to which a blade 32 served as a wind turbine is rotatably supported by a double-row self-aligning roller bearing 35 (hereinafter, also merely referred to as a bearing 35) disposed in a nacelle 34, and further a speed increaser 36 and a generator 37 are disposed in the nacelle 34. The speed increaser 36 increases the rotation speed of the rotor shaft 33 and transmits the rotation to an input shaft of the generator 37. The nacelle 34 is disposed on a support base 38 to be allowed to revolve via a revolving seat bearing 47. When a motor 39 for revolving (see FIG. 8) is driven, the nacelle 34 is revolved via a speed reducer 40 (see FIG. 8). The nacelle 34 is revolved to match the direction of the blade 32 with a wind direction. Two bearings 35 for supporting the rotor shaft are disposed in the example shown in FIG. 8, however the number of the bearings 35 may be one.

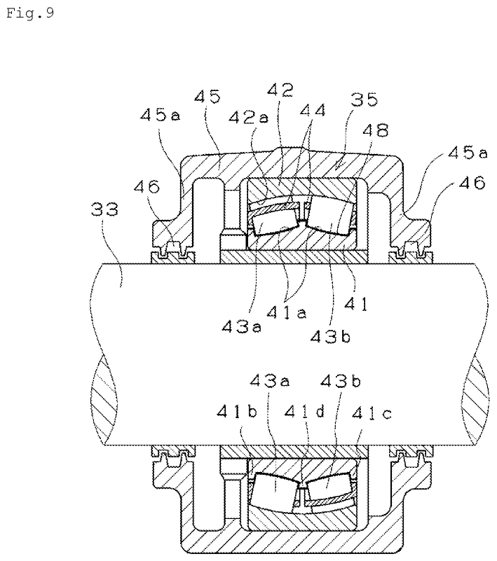

FIG. 9 shows the double-row self-aligning roller bearing 35 that supports the rotor shaft of the wind power generator. The bearing 35 is provided with an inner ring 41 and an outer ring 42 that are served as a pair of raceway rings, and a plurality of rollers 43 interposed between the inner ring 41 and the outer ring 42. The rollers are interposed to be aligned in two rows in an axial direction of the bearing. In FIG. 9, the roller 43a is in a row closer to the blade (left row), and the roller 43b is in a row far away from the blade (right row). The bearing 35 is a radial bearing that can receive a thrust load. An outer ring raceway surface 42a of the bearing 35 is formed in a spherical shape. Each of the rollers is formed such that an outer circumference is formed in a spherical shape along the outer ring raceway surface 42a. A double-row inner ring raceway surface 41a having a section along outer circumferences of the roller 43a and the roller 43b at the left and right rows is formed on the inner ring 41. Small flanges 41b and 41c are disposed at both ends of the outer circumference of the inner ring 41. An intermediate flange 41d is disposed at the center part of the outer circumference of the inner ring 41, namely between the roller 43a in the left row and the roller 43b in the right row. Each of the rollers 43a and 43b is retained in each row by a cage 44.

In the configuration described above, the outer circumference of each of the rollers 43a and 43b is brought into rolling contact with the inner ring raceway surface 41a and the outer ring raceway surface 42a. An inner end surface in the axial direction of the roller 43a is brought into sliding contact with one end surface in the axial direction of the intermediate flange 41d. An outer end surface in the axial direction of the roller 43a is brought into sliding contact with an inner end surface of the small flange 41b. An inner end surface in the axial direction of the roller 43b is brought into sliding contact with the other end surface in the axial direction of the intermediate flange 41d. An outer end surface in the axial direction of the roller 43b is brought into sliding contact with an inner end surface of the small flange 41c. The grease is sealed to reduce these frictions. As the grease, known grease for the rolling bearing can be adopted.

In FIG. 9, the outer ring 42 is disposed to be fitted with an inner diametrical surface of the bearing housing 45, and the inner ring 41 is fitted with an outer circumference of the rotor shaft 33 to support the rotor shaft 33. The bearing housing 45 has side walls 45a that cover both ends of the bearing 35, and a seal 46 such as a labyrinth seal is formed between the side walls 45a and the rotor shaft 33. The bearing 35 without a seal is adopted because the sealing can be obtained in the bearing housing 45. The bearing 35 is served as the wind power generator rotor shaft bearing according to the embodiment of the present invention.

The double-row self-aligning roller bearing described above has a feature that the hard film having a predetermined structure is formed on the surfaces of the roller and other component that are brought into rolling and sliding contact with each other (in particular, in a boundary lubrication state). Thus, superior peeling resistance of the hard film can be obtained even in contacting with other component in an inferior lubrication state causing sliding. Further, when the bearing is used for the wind power generator rotor shaft, foreign matters might be mixed into the bearing from an outside. However, since the hard film is formed, superior peeling resistance can be obtained even in a state in which the foreign matters are mixed. Further, since the swelling of the indentation caused on a bearing rolling surface is removed by a cutting effect due to the hard film, peeling caused by the indentation can be favorably prevented. As a result, the original properties of the hard film can be shown, and superior seizure resistance, wear resistance, and corrosion resistance thereof can be obtained. Consequently, the damage of the double-row self-aligning roller bearing caused by metal contact can be prevented.

An area on which the hard film is formed will be described below. In the bearing 35 shown in FIG. 9, a hard film 48 is formed on an outer circumference of the inner ring 41, which is a bearing component. The outer circumference of the inner ring 41 includes the raceway surface 41a, both end surfaces in the axial direction of the intermediate flange 41d, the inner end surface of the small flange 41b, and the inner end surface of the small flange 41c. In the configuration shown in FIG. 9, the hard film 48 is formed on a whole of the outer circumference of the inner ring 41 and also the hard film 48 is formed on a surface that is not brought into rolling and sliding contact with the rollers 43a and 43b. The area of the inner ring 41 on which the hard film 48 is formed is not limited to the configuration shown in FIG. 9 as long as the hard film 48 is formed on the surface that is brought into sliding contact with the roller in the boundary lubrication state. For example, the hard film may be formed on at least one of the end surface among both end surfaces in the axial direction of the intermediate flange 41d, the inner end surface of the small flange 41b, and the inner end surface of the small flange 41c that are brought into sliding contact with each of the rollers 43a and 43b.

As described above, in the self-aligning roller bearing as the power generator rotor shaft bearing, the roller (roller 43b) in a row far away from the blade receives a large thrust load compared to the roller (roller 43a) in a row closer to the blade. In this case, the area brought into sliding contact with the roller 43b is apt to be especially the boundary lubrication. Thus, considering that loads different in magnitude from each other are applied to the rollers in two rows aligned in the axial direction, the hard film may be formed only on the inner end surface of the small flange 41c among the small flanges 41b and 41c.

In the double-row self-aligning roller bearing described above, the hard film is formed on the surface to be brought into sliding contact (in particular, rolling and sliding contact) with other bearing component in the boundary lubrication state (low lambda condition). The roller causes sliding while rolling between the inner ring and the outer ring. The hard film shown in FIG. 9 is used under such a condition. Further, the area on which the hard film is formed is not limited to the area shown in FIG. 9. Therefore, the hard film may be formed on any surface of at least one bearing component selected from among the inner ring, the outer ring, the roller, and the cage that are to be brought into the condition described above.

In the configuration shown in FIG. 9, the hard film 48 is formed on the outer circumference of the inner ring 41, however, instead of this or in addition to this, the hard film 48 may be formed on the surfaces of each of the outer ring 42 and the rollers 43a and 43b. In a configuration in which the hard film is formed on the outer ring 42, it is preferable that the hard film is formed on an inner circumference (including outer ring raceway surface 42a) of the outer ring 42. Further, in a configuration in which the hard film is formed on the surfaces of the rollers 43a and 43b, the hard film may be formed on both end surfaces of each of the rollers 43a and 43b. Further, considering that the difference of loads applied to the rollers, the hard film may be formed on both end surfaces of only the roller 43b. Further, the hard film may be formed on the outer circumference of each of the rollers 43a and 43b. For example, the hard film may be formed on the outer circumference of the roller in at least one of the two rows.

Hereinafter, a forming method of the hard film will be described. The hard film is obtained by forming the foundation layer 8a, the mixed layer 8b, and the surface layer 8c in this order on a surface of the bearing component on which the hard film is to be formed.

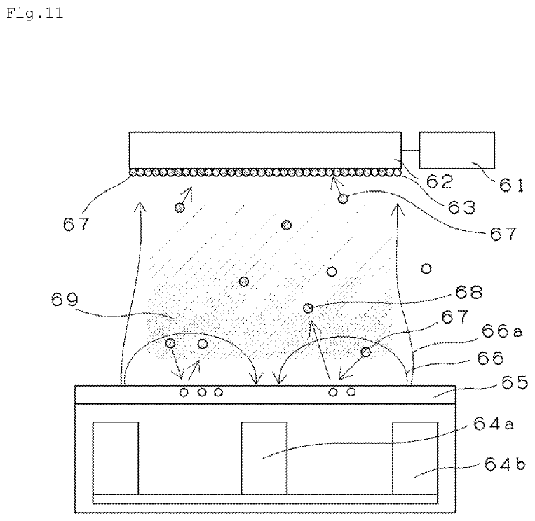

It is preferable that the foundation layer 8a and the mixed layer 8b are formed by using a UBMS apparatus that uses Ar gas as a sputtering gas. The film forming principle of a UBMS method to be carried out by using the UBMS apparatus is described with reference to a schematic view shown in FIG. 11. In FIG. 11, a base material 62 corresponds to each of the inner ring, the outer ring, the rolling element, and the cage, which are the bearing components on which the hard film is to be formed, however the base material is illustrated as a flat plate. As shown in FIG. 11, the UBMS apparatus has an inner magnet 64a and an outer magnet 64b having different magnetic properties in the central portion of a round target 65 and the peripheral portion thereof. While a high-density plasma 69 is being formed in the neighborhood of the target 65, a part 66a of magnetic field lines 66 generated by the magnets 64a and 64b reaches the neighborhood of a base material 62 connected to a bias power source 61. An effect that Ar plasma generated along the magnetic field lines 66a in sputtering diffuses to the neighborhood of the base material 62 can be obtained. In the UBMS method, a dense film (layer) 63 can be formed owing to an ion assist effect that Ar ions 67 and electrons allow ionized targets 68 to reach the base material 62 along the magnetic field lines 66a which reach the neighborhood of the base material 62 more than normal sputtering methods.

In a case in which the foundation layer 8a is mainly formed of Cr and WC, a Cr target and a WC target are used in combination as the target 65. In forming the mixed layer 8b, (1) the WC target, (2) a graphite target, and the hydrocarbon-based gas if needed, are used. The target is replaced one by one in forming each layer.

In a case in which the foundation layer 8a has the gradient composition of Cr and WC described above, the foundation layer 8a is formed by continuously or stepwise increasing sputtering power to be applied to the WC target and continuously or stepwise decreasing the sputtering power to be applied to the Cr target. With this, the layer having a structure in which the content rate of Cr is decreased and the content rate of WC is increased toward a side of the mixed layer 8b can be obtained.

The mixed layer 8b is formed by continuously or stepwise increasing the sputtering power to be applied to the graphite target served as the carbon supply source and continuously or stepwise decreasing the sputtering power to be applied to the WC target. With this, the layer having the gradient composition in which the content rate of WC is decreased and the content rate of DLC is increased toward a side of the surface layer 8c.

The vacuum degree inside the UBMS apparatus (film forming chamber) in forming the mixed layer 8b is set to preferably 0.2-1.2 Pa. The bias voltage to be applied to the bearing component, which is the base material, is set to preferably 20-100 V. By setting the vacuum degree and the bias voltage in such ranges, the peeling resistance can be improved.

It is preferable that the surface layer 8c is also formed by using the UBMS apparatus that uses Ar gas as the sputtering gas. More specifically, the surface layer 8c is formed by the UBMS apparatus in such a way that carbon atoms generated from a carbon supply source using the graphite target and the hydrocarbon-based gas in combination is deposited on the mixed layer 8b in a condition in which a ratio of the amount of the hydrocarbon-based gas to be introduced into the UBMS apparatus is set to 1-15 to 100 which is the amount of the Ar gas to be introduced thereinto. In addition, it is preferably that the vacuum degree inside the apparatus is set to 0.2-0.9 Pa. These preferable conditions are described below.

By using the graphite target and the hydrocarbon-based gas in combination as the carbon supply source, the indentation hardness and the modulus of elasticity of the DLC film can be adjusted. As the hydrocarbon-based gas, methane gas, acetylene gas, and benzene can be adopted. Although the hydrocarbon-based gas is not especially limited, the methane gas is preferable from the viewpoint of cost and handleability. By setting a ratio of the amount of the hydrocarbon-based gas to be introduced into the UBMS apparatus to 1-15 (parts by volume), preferably 6-15, and more preferably 11-13 to 100 (parts by volume) which is the amount of the Ar gas to be introduced thereinto (into film forming chamber), the adhesiveness of the surface layer 8c to the mixed layer 8b can be improved without deteriorating the wear resistance of the surface layer 8c.

The vacuum degree inside the UBMS apparatus (film forming chamber) is set to preferably 0.2-0.9 Pa as described above. The vacuum degree is set to more favorably 0.4-0.9 Pa, further more preferably 0.6-0.9 Pa. When the vacuum degree inside the UBMS apparatus is less than 0.2 Pa, since the amount of the Ar gas inside the chamber is small, the Ar plasma might not be generated and thus the film might not be formed. When the vacuum degree inside the UBMS apparatus is more than 0.9 Pa, a reverse sputtering phenomenon might be caused easily and thus the wear resistance of the formed film might be deteriorated.

It is preferable that the bias voltage to be applied to the bearing component served as a base material is set to 50-150 V. The bias voltage is applied to the base material in such a way that the bias voltage is minus relative to the earth potential. For example, the bias voltage of 100 V means that the bias potential of the base material is −100 V relative to the earth potential.

### EXAMPLES

As the hard film used in the rolling bearing according to the present invention, the hard film was formed on a predetermined base material, and the properties of the hard film were evaluated. The peeling resistance and the like were evaluated using a reciprocation sliding test machine and a two-cylinder test machine.

The base material, the UBMS apparatus, and the sputtering gas used for the evaluation of the hard films are as described below.

(1) Base material property: quenched and tempered SUJ2 having the hardness of 780 Hv

(2) Base material: mirror-polished (0.02 μmRa) flat plate of SUJ2

(3) Mating material: grinding-finished (0.7 μmRa) SUJ2 ring (ϕ40×L12 sub-curvature of 60)

(4) UBMS apparatus: UBMS202 produced by Kobe Steel, Ltd.

(5) Sputtering gas: Ar gas

The condition of forming the foundation layer is described below. The inside of a film forming chamber is vacuumed to approximately 5×10⁻³ Pa, and the base material is baked by a heater. After the surface of the base material is etched by means of Ar plasma, a Cr/WC gradient layer in which the composition ratio between Cr and WC is gradient such that the content of Cr is much at a side of the base material and the content of WC is much at a side of the surface is formed by the UBMS method while adjusting the sputtering power applied to the Cr target and the WC target.

The condition of forming the mixed layer is described below. Similar to the foundation layer, the mixed layer is formed by the UBMS method. The mixed layer is formed as a WC/DLC gradient layer in which the composition ratio between WC and DLC is gradient such that the content of WC is much at a side of the foundation layer and the content of DLC is much at a side of the surface layer while supplying methane gas, which is a hydrocarbon-based gas, and adjusting the sputtering power applied to the WC target and the graphite target.

The condition of forming the surface layer is as shown in each of Tables.

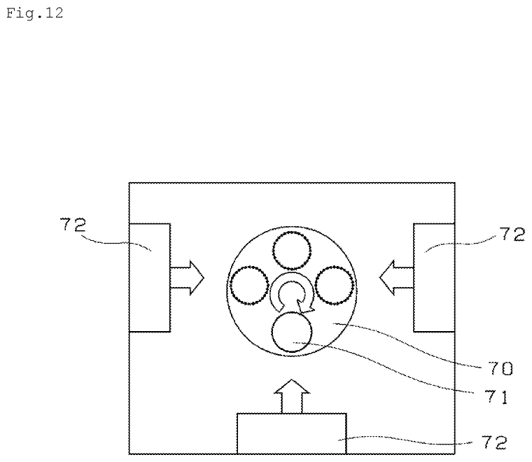

FIG. 12 is a schematic view illustrating the UBMS apparatus. As shown in FIG. 12, the UBMS apparatus has a UBMS function capable of controlling the property of a film deposited on a base material 71 arranged on a disk 70 by increasing a plasma density in the neighborhood of a base material 71 to enhance the ion assist effect (see FIG. 11), with a sputtering vaporization source material (target) 72 being subjected to an unbalanced magnetic field. This apparatus is capable of forming a composite film that combines any UBMS films (including a gradient composition), on the base material. In this example, the foundation layer, the mixed layer, and the surface layer are formed as the UBMS film on the ring served as the base material.

### Examples 1 to 6 and Comparative Example 1

After the base materials shown in Table 1 were ultrasonically cleaned with acetone, the base materials were dried. Thereafter, each of the base materials was mounted on the UBMS apparatus to form the foundation layer and the mixed layer in the film forming condition described above. The DLC film, which is the surface layer, was formed on each of the mixed layers in the film forming condition shown in Table 1 to obtain a specimen having a hard film. The hard film of Comparative example 1 corresponds to a conventional hard film having a film structure of three layers similar to the hard films of Examples 1 to 6. “Vacuum degree” shown in Table 1 means a vacuum degree inside the film forming chamber of the apparatus described above. The tests described below were performed using the obtained specimens. The results are also shown in Table 1.

### <Hardness Test>

The indentation hardness of each of the obtained specimens was measured by using a nano indenter (G200) produced by Agilent Technologies, Inc. Each of the measured values shows the average value of depths (position where hardness was uniform) not influenced by the surface roughness. The depth of each specimen was measured at 10 positions. Further, the obtained indentation hardness was converted into the Vickers hardness based on a conversion formula (Vickers hardness (HV)=Indentation hardness H_{IT} (N/mm²)×0.0945).

### <Film Thickness Test>

The film thickness of the hard film of each of the obtained specimens was measured by using a surface configuration and surface roughness measuring instrument (Form⋅Talysurf PGI830 produced by Taylor Hobson Ltd.). A film-formed portion was partly masked, and the film thickness was obtained from the difference in level between a film-unformed portion and the film-formed portion.

### <Reciprocation Sliding Test>

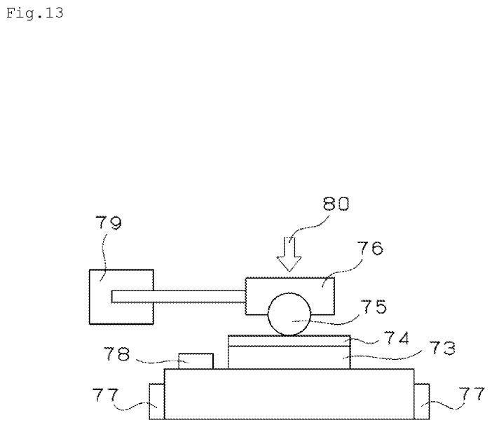

A test relating to the peeling resistance based on the sliding was performed for each of the obtained specimens by using a reciprocation sliding test machine shown in FIG. 13. As shown in FIG. 13, in the test, at first, a base material 73 (specimen) on which a hard film 74 is formed is disposed on a base to which a load cell 77 and an acceleration sensor 78 are mounted. Thereafter, a silicon nitride ball 75 to which a load 80 is applied is disposed on the hard film 74 of the specimen, and the silicon nitride ball 75 is reciprocated in a horizontal direction in the condition described below. The silicon nitride ball 75 is held by a mating material holder 76 connected to an exciting device 79. The reciprocation sliding test is performed in a non-lubrication state. The load is increased at a load increasing speed described below. A limit load (N) is obtained from the load when the friction coefficient is increased due to the peeling of the hard film. The maximum load is set to 120 N in Example 4, and the maximum load is set to 100 N in Example 5. A specific test condition is described below.

### (Test Condition)

Lubrication: non-lubrication

Ball: ⅜ inches of silicon nitride ball

Load: 30-80 N

Load increasing speed: 10 N/minute

Frequency: 60 Hz

Amplitude: 2 mm

TABLE 1

| | | | | | | | Comparative |
|---|---|---|---|---|---|---|---|
| | Examples | | | | | | example |
| | 1 | 2 | 3 | 4 | 5 | 6 | 1 |
| Base material | SUJ2 | SUJ2 | SUJ2 | SUJ2 | SUJ2 | SUJ2 | SUJ2 |
| Hardness of base | 780 | 780 | 780 | 780 | 780 | 780 | 780 |
| material (Hv) | | | | | | | |
| Surface roughness | 0.02 | 0.02 | 0.02 | 0.02 | 0.02 | 0.02 | 0.02 |
| of base material | | | | | | | |
| (μmRa) | | | | | | | |
| Material of | Cr/WC | Cr/WC | Cr/WC | Cr/WC | Cr/WC | Cr/WC | Cr/WC |
| foundation layer ¹⁾ | | | | | | | |
| Material of mixed | WC/DLC | WC/DLC | WC/DLC | WC/DLC | WC/DLC | WC/DLC | WC/DLC |
| layer ²⁾ | | | | | | | |
| Film forming | 3.0 | 3.0 | 10.0 | 12.0 | 12.0 | 6.0 | 3.0 |
| condition of | | | | | | | |
| surface layer | | | | | | | |
| Introduction | | | | | | | |
| ratio of methane | | | | | | | |
| gas ³⁾ | | | | | | | |
| Vacuum degree | 0.85 | 0.85 | 0.25 | 0.8 | 0.4 | 0.8 | 0.25 |
| (Pa) | | | | | | | |
| Bias voltage | 50 | 75 | 100 | 100 | 100 | 100 | 100 |
| (negative) (V) | | | | | | | |
| Indentation | 12.6 | 14.3 | 20.1 | 10.3 | 13.0 | 13.2 | 24.5 |
| hardness | | | | | | | |
| Average value | | | | | | | |
| (GPa) | | | | | | | |
| Converted | 1190 | 1348 | 1899 | 980 | 1230 | 1250 | 2315 |
| Vickers hardness | | | | | | | |
| Film thickness (μm) | 2.1 | 2.0 | 1.9 | 2.0 | 1.9 | 2.0 | 1.9 |
| Reciprocation | 80 or | 51.4 | 73.4 | 120 or | 100 or | 77.9 | 30.5 |
| sliding test (N = 2) | more | | | more | more | | |
| Limit load (N) | | | | | | | |
| (first time) | | | | | | | |
| Limit load (N) | 80 or | 54.6 | 80 | 120 or | 100 or | 83.4 | 46.9 |
| (second time) | more | | | more | more | | |

¹⁾ This layer corresponds to the foundation layer of Cr and WC in the present invention. In a case in which two components are mixed like the present invention, it shows “first component/second component”.
²⁾ This layer corresponds to the mixed layer of WC and DLC in the present invention. In a case in which two components are mixed like the present invention, it shows “first component/second component”.
³⁾ Introduction ratio corresponds to a ratio of an introduction amount (parts by volume) of methane gas to an introduction amount of 100 (parts by volume) of Ar gas.

Table 1 shows the film forming conditions of the respective layers and the results of the reciprocation sliding test. The reciprocation sliding test was performed two times for each Example and Comparative example, and the results of respective tests are shown. The base materials and the film forming conditions of the mixed layer adopted in Examples and Comparative example are identical to each other. As shown in Table 1, when the film forming conditions of the surface layers are changed so as to make the indentation hardness of the surface layers different from each other, the limit load becomes larger than that of the conventional hard film at a range of the indentation hardness of 9-22 GPa, which is lower than that of the conventional hard film. In particular, in a case in which the indentation hardness is in a range of 10-13 GPa (Examples 1, 4 and 5), the limit load is remarkably increased compared to the configuration in which the indentation hardness is 24.5 GPa (Comparative example 1). Consequently, it is found that the rolling bearing according to the present invention is superior in the peeling resistance even in an inferior lubrication state causing sliding contact.

### Examples 7 to 11 and Comparative Example 2 to 4

After the base materials shown in Table 1 were ultrasonically cleaned with acetone, the base materials were dried. Thereafter, each of the base materials was mounted on the UBMS apparatus to form the foundation layer and the mixed layer in the film forming condition described above. The DLC film, which is the surface layer, was formed on each of the mixed layers in the film forming condition shown in Table 2 to obtain a specimen having a hard film. The hard film of Comparative example 4 is a specimen formed of the base material itself without the hard film thereon. “Vacuum degree” shown in Table 2 means a vacuum degree inside the film forming chamber of the apparatus described above. The two tests as described below using a two-cylinder test machine were performed for each of the obtained specimens. The hardness test and the film thickness test were performed in accordance with the test methods described above. The results are also shown in Table 2.

### <Indentation Resistive Test Using Two-Cylinder Test Machine>

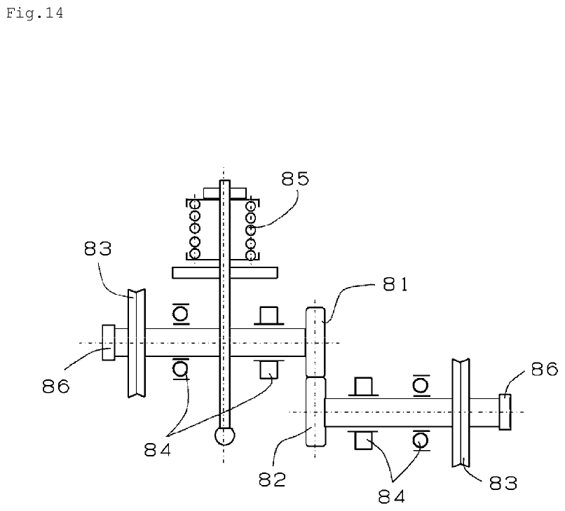

A peeling resistance test in a state in which foreign matters are mixed was performed for each of the obtained specimens by using a two-cylinder test machine shown in FIG. 14. The two-cylinder test machine is provided with a driving side specimen 81, and a driven side specimen 82 brought into rolling and sliding contact with the driving side specimen 81. Respective specimens (rings) are supported by support bearings 84, and a load is applied to the respective specimens by a loading spring 85. FIG. 14 also shows a driving pulley 83 and a non-contact rotation speed indicator 86. The hard film is only on the driven side specimen 82. The foreign matters are mixed between the driving side specimen 81 and the driven side specimen 82 to promote the peeling of the hard film, and then the peeling resistance of the hard film after driving was evaluated. A specific test condition is described below.

A peeling area was determined by binarizing the brightness of a range of 0.5 mm×0.5 mm on the rolling contact surface of the ring specimen, and a peeling rate in the measured range was calculated using the calculation formula below.

(Peeling rate in measured range)=(Peeling area)/(Binarized area)×100(%)

The peeling rate is an average of peeling rates in the measured ranges calculated at four positions (0°, 90°, 180°, and 270°) on the outer circumference of the ring specimen. (Test condition)

Lubrication oil: VG56 equivalent oil (foreign matter free oil), or VG56 equivalent oil with the following foreign matters mixed (foreign maters added oil)

Oil supply method: oil dropping

Foreign matters: high speed steel powder KHA30100-180 μm, 10 g/l

Oil temperature: 40-50° C.

Maximum contact surface pressure: 2.5 GPa

Rotation speed: (specimen side) 300 minute⁻¹, (mating material side) 300 minute⁻¹

Time: after tested for 1 hour with foreign matters added oil, tested until the number of load applications is 1×10⁶ with foreign matter free oil

### <Indentation Removability Test Using Two-Cylinder Test Machine>

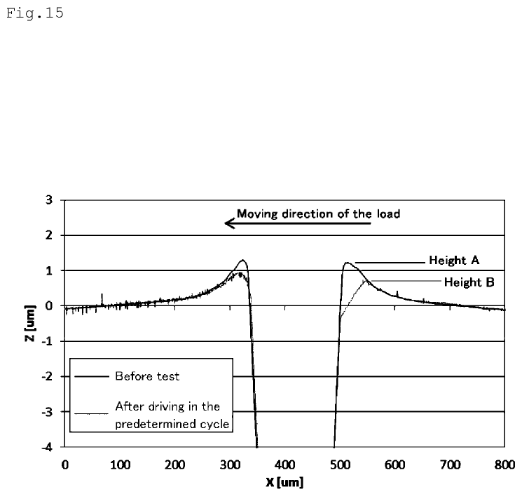

An indentation removability test was performed for each of the obtained specimens by using the two-cylinder test machine shown in FIG. 14. The hard film was only on the driven side specimen 82. The test was started in a state in which an indentation is formed on the driving side specimen 81 served as a mating material, and a change of a swelling part of the indentation was measured at a regular time interval. A change of an initial swelling height of the indentation (height A before test) with the lapse of time was evaluated. FIG. 15 shows a measurement example of the swelling height of the indentation. The swelling height of the indentation formed on the driving side specimen is approximately 1.2-1.4 μm. The generatrix passing the center of the indentation was acquired and the maximum value of the generatrix corrected by a radius of the specimen was measured as the swelling height of the indentation. Since there is a difference of scraping of the swelling in a moving direction of the load, the swelling height of the indentation at an upstream side in the moving direction of the load is adopted. The residual rate of the swelling height of the indentation was evaluated using the calculation formula below.

(Residual rate of indentation)=(Height B after test)/(Height A before test)×100(%)

### (Test Condition)

Lubrication oil: VG56 equivalent oil (including additive)

Oil supply method: oil dropping

Indentation forming condition: Rockwell test diamond indenter of 15 kgf

Oil temperature: 40-50° C.

Maximum contact surface pressure: 2.5 GPa

Rotation speed: (specimen side) 300 minute⁻¹, (mating material side) 300 minute⁻¹

Time cycle: tested until the number of load applications is 1×10⁶

TABLE 2

| | Examples | | | | Comparative examples | | |
|---|---|---|---|---|---|---|---|
| | 7 | 8 | 9 | 10 | 2 | 3 | 4 |
| Base material | SUJ2 | SUJ2 | SUJ2 | SUJ2 | SUJ2 | SUJ2 | SUJ2 |
| Hardness of base | 780 | 780 | 780 | 780 | 780 | 780 | 780 |
| material (Hv) | | | | | | | |
| Surface roughness | 0.01 | 0.01 | 0.01 | 0.01 | 0.01 | 0.01 | 0.01 |
| of base material | | | | | | | |
| (μmRa) | | | | | | | |
| Material of | Cr/WC | Cr/WC | Cr/WC | Cr/WC | Cr/WC | Cr/WC | No hard |
| foundation layer ¹⁾ | | | | | | | film |
| Material of mixed | WC/DLC | WC/DLC | WC/DLC | WC/DLC | WC/DLC | WC/DLC | |
| layer ²⁾ | | | | | | | |
| Film forming | 3.0 | 3.0 | 3.0 | 10.0 | 3.0 | 3.0 | |
| condition of | | | | | | | |
| surface layer | | | | | | | |
| Introduction | | | | | | | |
| ratio of | | | | | | | |
| methane gas ³⁾ | | | | | | | |
| Vacuum degree | 0.85 | 0.85 | 0.85 | 0.25 | 0.25 | 0.25 | |
| (Pa) | | | | | | | |
| Bias voltage | 35 | 50 | 75 | 100 | 150 | 100 | |
| (negative) (V) | | | | | | | |
| Indentation | 10.4 | 12.6 | 14.3 | 20.1 | 28.2 | 24.5 | |
| hardness | | | | | | | |
| Average value | | | | | | | |
| (GPa) | | | | | | | |
| Converted | 980 | 1190 | 1348 | 1899 | 2690 | 2315 | |
| Vickers | | | | | | | |
| hardness | | | | | | | |
| Film thickness | 1.9 | 2.1 | 2 | 1.9 | 2.0 | 1.9 | |
| (μm) | | | | | | | |
| Indentation | 1 | 1 | 3 | 9 | 63 | 24 | |
| adding rolling | | | | | | | |
| test | | | | | | | |
| 1 × 10⁶ cycle | | | | | | | |
| peeling rate | | | | | | | |
| (%) | | | | | | | |
| Indentation | 74 | 68 | 59 | 43 | 3 | 11 | 77 |
| removing test | | | | | | | |
| 1 × 10⁶ cycle | | | | | | | |
| indentation | | | | | | | |
| residual rate | | | | | | | |
| (%) | | | | | | | |

¹⁾ This layer corresponds to the foundation layer of Cr and WC in the present invention. In a case in which two components are mixed like the present invention, it shows “first component/second component”.
²⁾ This layer corresponds to the mixed layer of WC and DLC in the present invention. In a case in which two components are mixed like the present invention, it shows “first component/second component”.
³⁾ Introduction ratio corresponds to a ratio of an introduction amount (parts by volume) of methane gas to an introduction amount of 100 (parts by volume) of Ar gas.

According to the result of the test, each of the hard films having relatively high hardness (Comparative examples 2 and 3) has an ability to remove the swelling of the indentation on the mating material, while the peeling resistance is inferior in the condition in which the foreign matters are mixed. On the other hand, each of the hard films having relatively low hardness (Examples 7 to 10) is inferior in the indentation removing ability compared to Comparative examples 2 and 3, while the peeling resistance against the foreign matters mixture is largely improved. In particular, in each of Examples 7 and 8 of which the indentation hardness is 10-15 MPa, the peeling of the hard film is hardly caused. Consequently, it is found that the rolling bearing according to the present invention is superior in the peeling resistance even in the lubrication state in which the foreign matters are mixed.

### INDUSTRIAL APPLICABILITY

It is likely that the sliding surface or the rolling contact surface to which the DLC film is to be applied is inferior in its lubrication state such as less lubrication or high sliding speed. In particular, the sliding and rolling in the lubrication oil into which foreign matters are mixed is severer. The rolling bearing according to the present invention has, for example, the DLC film formed on the outer ring raceway surface or the rolling contact surface of the rolling element and the rolling bearing is superior in the peeling resistance of the DLC film even when operated in a severe lubrication state (for example, a lubrication condition with inferior lubrication state causing sliding or a lubrication condition with the foreign matters mixed), and thereby the rolling bearing shows the properties of the DLC itself. Consequently, the rolling bearing is superior in its seizure resistance, wear resistance, and corrosion resistance. Thus, the rolling bearing according to the present invention can be applied to various uses including a use in the severe lubrication state. In particular, the rolling bearing according to the present invention is suitable to be applied to the wheel support device or the wind power generation rotor shaft support device.

### REFERENCE SIGNS LIST

1: deep groove ball bearing (rolling bearing)
2: inner ring
3: outer ring
4: rolling element
5: cage
6: sealing member
7: grease
8: hard film
11: steering knuckle
12: flange
13: axle
14: tapered roller bearing (rolling bearing)
15: axle hub (rotation member)
16: flange
17: stud bolt
18: nut
19: brake drum
20: wheel disc
21: rim
22: back plate
23: grease cap
24: outer ring
25: inner ring
26: cage
27: tapered roller
28: hard film
31: wind power generator
32: blade
33: rotor shaft
34: nacelle
35: double-row self-aligning roller bearing (rolling bearing)
36: speed increaser
37: generator
38: support base
39: motor
40: speed reducer
41: inner ring
42: outer ring
43: roller
44: cage
45: bearing housing
46: seal
47: revolving seat bearing
48: hard film

1. A rolling bearing comprising:
an inner ring having an inner ring raceway surface on an outer circumference;
an outer ring having an outer ring raceway surface on an inner circumference;
rolling elements that roll between the inner ring raceway surface and the outer ring raceway surface;
a cage that retains the rolling elements, wherein the inner ring, the outer ring, the rolling elements, and the cage are formed of iron-based material; and
a hard film comprising: a foundation layer formed directly on a surface of at least one bearing component selected from among the inner ring, the outer ring, the rolling element, and the cage; a mixed layer formed on the foundation layer and mainly formed of tungsten carbide and diamond-like carbon; and a surface layer formed on the mixed layer and mainly formed of diamond-like carbon, the hard film being configured to be brought into rolling contact and sliding contact with other bearing component,
wherein:
the indentation hardness of the surface layer measured by a method defined in ISO 14577 is 9-22 GPa; and
the mixed layer has a composition in which a content rate of the tungsten carbide in the mixed layer is continuously or stepwise decreased and a content rate of diamond-like carbon in the mixed layer is continuously or stepwise increased from a side of the foundation layer toward a side of the surface layer.

2. The rolling bearing according to claim 1, wherein the indentation hardness of the surface layer is 10-15 GPa.

3. The rolling bearing according to claim 1, wherein the surface layer has a gradient layer of which the indentation hardness is smaller than that of the surface layer, at a side of the mixed layer.

4. The rolling bearing according to claim 1, wherein the iron-based material is high carbon chromium bearing steel, carbon steel, tool steel, or martensitic stainless steel.

5. The rolling bearing according to claim 1, wherein the foundation layer is mainly formed of chromium and tungsten carbide.

6. A wheel support device comprising the rolling bearing according to claim 1 mounted to an outer diametrical surface of an axle to rotatably support a rotation member that is rotated together with a wheel.

7. The wheel support device according to claim 6,
wherein:
the rolling bearing is a tapered roller bearing comprising an end surface at a large diameter side of a tapered roller, which is the rolling element, and an end surface of a large flange formed on the inner ring;
the end surface at the large diameter side of the tapered roller is configured to be brought into rolling contact and sliding contact with the end surface of the large flange; and
the hard film is formed on at least one of the end surface at the large diameter side of the tapered roller and the end surface of the large flange of the inner ring.

8. The rolling bearing according to claim 1 configured to support a rotor shaft to which a blade of a wind power generator is mounted,
wherein:
the rolling bearing is formed as a double-row self-aligning roller bearing comprising rollers interposed between the inner ring and the outer ring, as the rolling elements to be aligned in two rows in an axial direction;
the outer ring raceway surface is formed in a spherical shape; and
the outer circumference of each of the rollers is formed in a shape along the outer ring raceway surface.

9. The rolling bearing according to claim 8,
wherein the inner ring comprises: an intermediate flange disposed on the outer circumference of the inner ring, between the rollers in the two rows, the intermediate flange being configured to be brought into sliding contact with an end surface at an inner side in the axial direction of each of the rollers; and small flanges disposed at both ends of the outer circumference of the inner ring, each of the small flanges being configured to be brought into sliding contact with an end surface at an outer side in the axial direction of each of the rollers; and
wherein the hard film is formed on the outer circumference of the roller in at least one of the two rows.

10. A wind power generation rotor shaft support device comprising one or more bearings disposed in a housing, the bearings being configured to support a rotor shaft to which a blade is mounted,
wherein at least one of the bearings is formed as the double-row self-aligning roller bearing according to claim 8, and
wherein a part of the double-row self-aligning roller bearing, in a row far away from the blade is configured to receive a large load compared to a part of the double-row self-aligning roller bearing, in a row close to the blade.
